(19) United States
(12) Patent Application Publication
(10) Pub. No.: US 2004/0032845 A1
(43) Pub. Date: Feb. 19, 2004

(54) AUTONOMOUS UPDATING OF A VIRTUAL ACTIVE SET FOR A WIRELESS DEVICE

(76) Inventor: Rex Huan-Yueh Chen, Chi-Lung City (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,041

(22) Filed: Mar. 12, 2003

Related U.S. Application Data
(60) Provisional application No. 60/319,466, filed on Aug. 13, 2002.

(51) Int. Cl. H04Q 7/24

(52) U.S. Cl. 370/338; 370/349; 370/409

(57) ABSTRACT

43The cell size of a virtual active set is forced to be conformal to that imposed upon an active set. Hence, events that would normally lead to the addition of a cell to the virtual active set are ignored if the virtual active set is full, and are not reported to avoid unnecessary radio traffic. To improve flexibility, both “Intra-frequency reporting criteria” and “Inter-frequency reporting criteria” structures can be present simultaneously in a MEASUREMENT CONTROL message. When processing a MEASUREMENT CONTROL message, if no “Inter-frequency set update” structure is included and “UE autonomous update mode” stored in the UE is “Off”, the UE does not remove the virtual active set, but continues to use it for Inter-frequency measurements. If the “Replacement activation threshold”IE or “Reporting deactivation threshold” IE included in a “Intra-Frequency measurement”IE has changed with respect to those already stored in the UE, or if the number of cells on non-used frequency Fᵢ considered in that inter-frequency measurement is changed, the UE initializes the virtual active set with the best Nᵢ cells for each non-used frequency and reports all the cells included in the initialized virtual active set to the UTRAN.

### CROSS REFERENCE TO RELATED APPLICATIONS

The application claims the benefit of U.S. Provisional Application No. 60/319,466, filed Aug. 13, 2002, and included herein by reference.

### BACKGROUND OF INVENTION

1. Field of the Invention

The present invention relates to a wireless communications device. More particularly, the present invention relates to the autonomous updating of a virtual active set by the wireless device, which is used for signal quality measurements.

2. Description of the Prior Art

The 3^{rd} Generation Partnership Project (3GPP) specification 3GPP TS 25.331 V3.11.0 (2002-06) “Radio Resource Control (RRC) Protocol Specification”, which is included herein by reference, provides technical description of a Universal Mobile Telecommunications System (UMTS). Familiarity with 3GPP protocols is assumed in the following. The UMTS discloses a mobile device, termed user equipment (UE), in wireless communications with one or more base stations. These base stations, called Node Bs, and Radio Network Controllers (RNC), are collectively termed the UMTS Terrestrial Radio Access Network, or UTRAN for short. From time to time, the UTRAN may instruct the UE to utilize a different frequency for communications, which is termed an inter-frequency handover. For inter-frequency handovers, the UTRAN first needs to determine which frequency has the best signal quality for the UE to utilize for connection purposes. The UE performs inter-frequency measurements to assist the UTRAN in making this decision, and the Radio Resource Control (RRC) layer of the UE sends MEASUREMENT REPORT messages to its peer entity on the UTRAN side that contain the results of these measurements. Section 8.4.2 of the above-noted 3GPP specification TS 25.331 discusses such messages.

The signal quality of a frequency is evaluated by the frequency quality estimate formula, as described in section 14.2.0b of TS 25.331. A used frequency is a frequency that the UE has been ordered to measure upon, and which the UE is also currently using for the connection. The UE does not measure the signal quality from merely a single cell, but can actually incorporate several cells that are included in an active set or a virtual active set. The concept of an “active set”, which is defined as the set of radio links simultaneously involved in a specific communication service between a UE and a UTRAN access point (i.e. the set of cells involved in a soft handover), can be used to improve the overall signal quality since the UE can combine all the signals coming from the different cells included in the active set. For the used frequency, all the cells included in the active set are considered in the quality estimate of the used frequency. But for a non-used frequency, i.e. a frequency that the UE has been ordered to measure upon but which is not used for the connection, there is no mechanism like the active set that is used to calculate the quality estimate of the non-used frequency. Therefore, in order to compare the signal quality between different frequencies under conditions that are similar and hence fair, the concept of a virtual active set was introduced. The virtual active set is treated as the active set associated with a non-used frequency.

It is the UTRAN that controls the measurement-related configuration of the UE by way of a MEASUREMENT CONTROL message that is sent from the RRC of the UTRAN to the peer entity RRC on the UE. Section 8.4.1 of TS 25.331 discusses this message. The UE can be configured to autonomously update the virtual active set. That is, the UE will add cells to and remove cells from the virtual active set without direct instructions from the UTRAN to do so. This is controlled by an Information Element (IE) stored within the UE called the “UE autonomous update mode” IE. A general discussion of the virtual active set is found in section 14.11 of TS 25.331. For a UE that is configured for autonomous updates of the virtual active set, i.e. the IE “UE autonomous update mode” is set to “On” or “On with no reporting”, the virtual active set is initialized with the best number of cells Nᵢ for each non-used frequency, as discussed in sub-section 14.11.1 of TS 25.331. For inter-frequency measurements it is possible to specify intra-frequency measurement reporting events to support the maintenance of the virtual active set, and these are specified by the IE “Intra-Frequency measurement reporting criteria”, which is stored for that inter-frequency measurement. The virtual active set could be updated either based on the “Intra-Frequency measurement reporting criteria” IE, or based on events of type 1a, 1b and 1c that were defined for the used frequency in other stored measurements of type “intra-frequency” at the time the inter-frequency measurement was set up. More detailed information regarding the initiation and updating of the virtual active set are described in TS 25.331, sections 14.11.1 and 14.11.2, respectively. Detailed discussion of intra-frequency measurements can be found in TS 25.331, section 14.1. In particular, reporting event 1a is discussed in sub-section 14.1.2.1, event 1b is discussed in sub-section 14.1.2.2, and reporting event 1c is discussed in 14.1.2.3. Inter-frequency measurements are discussed in TS 25.331, section 14.2. The related IEs, which are included in the MEASUREMENT CONTROL message, are listed in TS 25.331, section 10.3.7.16 (“inter-frequency measurement” IE) and section 10.3.7.22 (“Inter-frequency SET UPDATE” IE).

The UE maintains a variable “maxRL”, which indicates the maximum number of radio links (RLs) that may be contained within the active set. The active set cannot contain more than “maxRL” RLs. However, the prior art places no equivalent restriction upon the virtual active set. Hence, it is possible for the UE to add more than “maxRL” cells into the virtual active set. As a result, measurement comparisons between the active set and the virtual active set are potentially misleading. Additionally, if the “Reporting deactivation threshold” is equal to “0” (i.e. not applicable), the UE will inform the UTRAN each time a 1a type event occurs. Such reporting will be performed even if the number of cells within the active set is equal to or exceeds “maxRL”, which is unnecessary as the UTRAN cannot add more than “maxRL” cells to the active set. Unnecessary reporting events are thus performed, wasting radio resources.

The UE keeps track of a variable “NCells Fi”, which is the number of cells on frequency Fi considered in that inter-frequency measurement. Typically, the maximum possible value of “NCells Fi” is 32, and the value of “maxRL” is 8. The formula used for calculating Nᵢ is found in section 14.11.1 of TS 25.331. However, as “NCells Fi” can be larger than “maxRL”, it is possible that the formula used to calculate the value of Nᵢ can yield results that are larger than “maxRL”. Consequently, when the virtual active set is filled with the Nᵢ best cells, it is possible that greater than “maxRL” cells will be placed into the virtual active set. Due to the current frequency quality estimate formula defined in sub-section 14.2.0b.1 of TS 25.331, the more cells included in the virtual active set will always lead to an estimated quality of the virtual active set on frequency j being better. This will again cause misleading signal comparisons between the virtual active set and its true performance as an active set.

The data structure of the MEASUREMENT CONTROL message also places undue limitations on the UMTS. In particular, the“Intra-frequency measurement reporting criteria” IE and the “Inter-frequency measurement reporting criteria” IE cannot both be present (indicated in section 10.3.7.16 of TS 25.331) as these two IEs are included in the message as“CHOICE report criteria”. That is, one may be present, or the other, but not both. The UTRAN is thus unable to assign to a UE configurations that command the UE to perform both autonomous updating of the virtual active set and inter-frequency measurement reporting. By way of example, if the UTRAN configures a UE to perform autonomous updating of the virtual active set (i.e. the IE “Intra-frequency measurement reporting criteria” is included), then the UTRAN cannot, with the same MEASUREMENT CONTROL message, configure the UE to perform inter-frequency measurement reporting. Under such circumstances, the UE is only required to maintain the virtual active set, and does not need to send any inter-frequency measurement reports to the UTRAN, since the IE “Inter-frequency measurement reporting criteria” could not be included in the original MEASUREMENT CONTROL message. As a result, the UTRAN is precluded from configuring the UE to perform both autonomous updating of the virtual active set and inter-frequency measurement reporting.

Another problem is present in the manner in which the UE processes a received MEASUREMENT CONTROL message from the UTRAN. According to the prior art, if the “Inter-frequency set update” IE is not included in the message, and if the “UE autonomous update mode” IE currently stored in the UE for the inter-frequency measurement is set to “Off”, the UE shall remove the possibly existing virtual active set of the non-used frequency considered in that measurement and consider the virtual active set for it as empty. A consequence of this, though, is that if the IE “UE autonomous update mode” is set to “Off” within the UE and if the UTRAN would like to modify some IEs of this measurement that are not related to the initializing or updating of the virtual active set, then the IE “Inter-frequency set update” (which is an optional IE) should always be included in the message, and the “UE autonomous update mode” IE should be set to “Off”, even though the UTRAN does not wish to modify any IE related to the initializing or updating of the virtual active set of this measurement. Failure to do so will result in the UE removing the possibly existing virtual active set. It is noted that the UTRAN has available the option of using the “Radio link removal information”IE to remove any and all cells included within the virtual active set, instead of relying on the above. The message size is thus forced to be unnecessarily large.

If the “UE autonomous update mode” IE received or previously stored on the UE is set to “on” or “on with no reporting”, the UE initializes the virtual active set with the best Nᵢ cells for each non-used frequency. If the “UE autonomous update mode” IE received or previously stored is set to “on”, the UE reports all the cells included in the initial virtual active set to the UTRAN. This, however, can cause unnecessary actions and message transmissions on the part of the UE. For example, if the previously stored “UE autonomous update mode” IE is set to “on” and the current received “UE autonomous update mode” IE is set to “off”, the UE initializes the virtual active set and reports all of the cells included in the newly initialized virtual active set to UTRAN, and then immediately removes this newly initialized virtual active set of the non-used frequency considered in that measurement. Unnecessary actions are thus performed by the prior art UE (an unnecessary initializing of the virtual active set, and an unnecessary message transmission to the UTRAN to report all the cells included in the new virtual active set), since the initialized virtual active set is simply immediately removed. In the prior art does not consider that if parameter used for calculating the virtual active set changed, e.g. if the received “Replacement activation threshold” IE or the “Reporting deactivation threshold” IE included in the “Intra-Frequency measurement” IE changed, or if the number of neighboring cells changed, UE should also recalculate the virtual active set and report all cells included in the virtual active set to UTRAN.

### SUMMARY OF INVENTION

It is therefore a primary objective of this invention to provide a method and related UMTS, with appropriate data structures, to solve the above-noted problems of the prior art.

In a preferred embodiment, the present invention discloses a method, and associated wireless device, for maintaining a virtual active set for the wireless device. The cell size of the virtual active set is forced to be conformal to the cell size that is imposed upon the active set. Hence, events (type 1a) that would normally lead to the addition of a cell to the virtual active set are ignored if the virtual active set is full, and are not reported to avoid unnecessary radio traffic. User equipment (UE)always keeps the number of cells included in the virtual active set less than or equal to “maxRL”, which is the maximum number of cells permitted within the active set. To improve flexibility, both “Intra-frequency reporting criteria” and “Inter-frequency reporting criteria” structures can be present simultaneously in a MEASUREMENT CONTROL message. When processing a MEASUREMENT CONTROL message, if no “Inter-frequency set update” structure is included and “UE autonomous update mode” stored in the UE is “Off”, the UE does not remove the virtual active set, but continues to use it for Inter-frequency measurements. If the “Replacement activation threshold”IE or “Reporting deactivation threshold” IE included in a “Intra-Frequency measurement”IE has changed with respect to those already stored in the UE, or if the number of cells on non-used frequency Fᵢ considered in that inter-frequency measurement is changed, the UE initializes the virtual active set with the best Nᵢ cells for each non-used frequency and reports all the cells included in the initialized virtual active set to the UTRAN.

It is an advantage of the present invention that by keeping the number of cells in the virtual active set less than or equal to “maxRL”, the present invention ensures that signal measurements based upon the virtual active set will be consistent with the requirements imposed upon the active set.

It is a further advantage of the present invention that by ignoring type 1a events when the virtual active set is full (i.e., has “maxRL” cells), unnecessary reporting between the UE and the UTRAN is eliminated, thus conserving radio resources.

It is yet a further advantage of the present invention that by enabling a MEASUREMENT CONTROL message to contain both “Intra-frequency reporting criteria” and “Inter-frequency reporting criteria” Information Elements (IEs), the present invention reduces the number of MEASUREMENT CONTROL messages that must be sent to the UE, further conserving radio resources.

Yet another advantage of the present invention is that, by causing the UE to keep the virtual active set when processing a MEASUREMENT CONTROL message that has no “Inter-frequency set update” IE when the “UE autonomous update mode” IE stored in the UE is “Off”, the present invention removes the necessity of the UTRAN to include an “Inter-frequency set update” IE simply to prevent the virtual active set from being discarded. This, in turn, enables for smaller signalling message sizes, and thus conserves radio resources.

Another advantage of the present invention is that by initialising the virtual active set when parameters affecting Nᵢ are changed, the present invention ensures that the virtual active set is as complete as possible, and thus provides the best possible signal measurement results to the UTRAN.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a simple block diagram of a user equipment (UE) according to the present invention.

FIG. 2 is an example message sequence chart of updating the virtual active set according to the present invention.

FIG. 3 is a simple message sequence chart that illustrates example processing of MEASUREMENT CONTROL messages according to the present invention method.

FIGS. 4A and 4B is a table of a first embodiment of a present invention “Inter-frequency measurement” information element (IE).

FIG. 5 is a table of a first embodiment of a present invention “Inter-frequency measurement quantity” IE.

### DETAILED DESCRIPTION

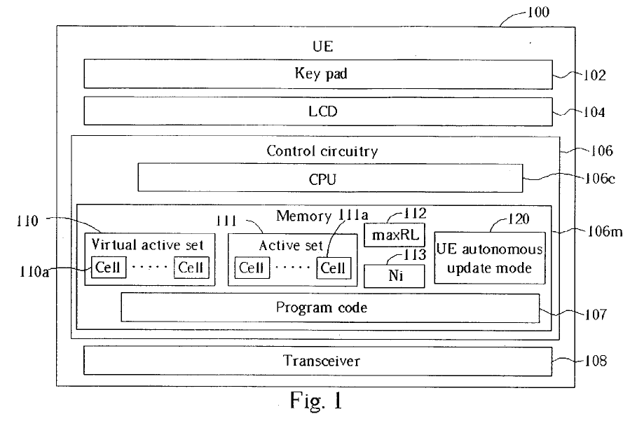

Please refer to FIG. 1. FIG. 1 is a block diagram of a user equipment (UE) 100 according to the present invention. In most respects, the present invention UE 100 is identical to a UE of the prior art. The UE 100 includes devices for accepting input and providing output, such as a keypad 102 and a liquid crystal display (LCD) 104, respectively. A transceiver 108 is capable of receiving wireless signals and providing corresponding data to a control circuit 106, and can also wirelessly transmit data received from the control circuit 106. The transceiver 108 is thus part of the 3GPP layer 1 stack of the present invention communications protocol. The control circuitry 106 is responsible for controlling the operations of the UE 100, and is used to implement the layer 2 and layer 3 stacks of the 3GPP communications protocol; in particular, for implementing the RRC layer, with suitable modification to accommodate the present invention. To this end, the control circuitry 106 includes a central processing unit (CPU) 106c in electrical communication with memory 106m, an arrangement familiar to those in the art of wireless communication devices. The memory 106m holds program code 107 that is used to implement the layer 2 and layer 3 stacks of the present invention communications protocol. With respect to a UE of the prior art, the present invention UE 100 has modifications to the program code 107 to implement the present invention method, providing modifications to the program code 107 that relate to the RRC layer so as to implement the present invention. These modifications should be well within the means of one reasonably skilled in the art after reading the following detailed description of the preferred embodiment.

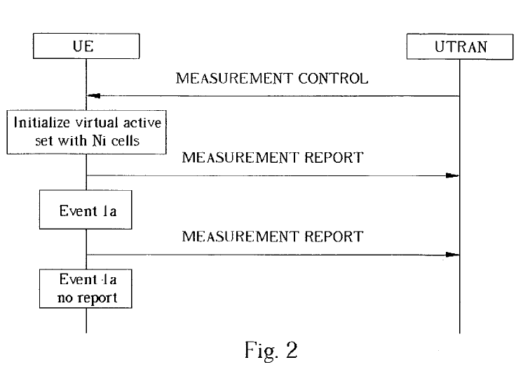

As with the prior art UE, the present invention UE 100 is capable of maintaining a virtual active set 110, which holds a list of cells 110a. Similarly, the UE 100 maintains an active set 111, which holds a list of cells 111a. As with the prior art, the number of cells 111a in the active set 111 is not permitted to exceed a value maxRL 112. As a first aspect of the present invention, the number of cells 110a in the virtual active set 110 is also prevented from exceeding maxRL 112, so as to ensure a fair comparison between the measurement values of the virtual active set 110 and the active set 111; or, rather, to ensure that the measurement values as applied to the virtual active set 110 correctly indicate how the virtual active set 110 would serve as the active set 111. If the virtual active set 110 already has maxRL 112 cells 110a and a 1a type event occurs, the UE 100 will not add any more cells 110a to the virtual active set 110. A noted in the prior art, a type 1a event occurs when a primary common pilot channel (CPICH) enters the reporting range. It is possible to replace one cell 110a with another, but the 1a type event will not cause the number of cells 110a to exceed maxRL 112. Additionally, to prevent unnecessary reporting, the UE 100 does not send a MEASUREMENT REPORT to the UTRAN if a 1a type event occurs and the virtual active set 110 is already full (i.e., already has maxRL 112 cells) and so is unchanged by the 1a event. Please refer to FIG. 2 with respect to FIG. 1. FIG. 2 is an example message sequence chart of updating the virtual active set 110. Initially, a MEASUREMENT CONTROL message is sent from the UTRAN to the UE 100, with the IE “UE autonomous update mode” set to “On”. In response to this message, the UE 100 initialises the virtual active set 110 with the Nᵢ 113 best cells 110a. Assume that Nᵢ 113 is one less than maxRL 112. The RRC layer of the UE 100 then sends a MEASUREMENT REPORT message to the UTRAN, which indicates this initialised virtual active set 110. Some time later, a 1a type event occurs, which the UE 100 processes. As the number of cells 110a in the virtual active set 110 is currently less than maxRL 112, the UE 100 adds the cell associated with 1a event to the virtual active set 110, and then sends a MEASUREMENT REPORT of this new virtual active set 110 to the UTRAN. At this time, then, there are maxRL 112 cells 110a in the virtual active set 110. Later still, another 1a type event occurs. However, because there are now maxRL 112 cells 110a in the virtual active set 110, the UE 100 does not add the cell associated with this 1a event into the virtual active set 110. Assuming that the “Reporting deactivation threshold” IE is equal to “0”, the UE 100 does not send a MEASUREMENT REPORT to the UTRAN to indicate this subsequent 1a event since the virtual active set 110 is unchanged by the last 1a event.

As in the prior art, the UE 100 can be configured to send MEASUREMENT REPORT messages to the UTRAN when certain measurement events related to the active set 111 occur, such as type 1a events. However, the program code 107 of the UE 100 is modified so that the UE 100 will not send such MEASUREMENT REPORT messages to the UTRAN indicative of 1a type events when the active set 111 is full, i.e., when the active set 111 has maxRL 112 cells 111a. In this manner, unnecessary reports are prevented from being sent to the UTRAN, and hence radio resources are conserved. The following steps indicate how reporting event 1a is handled by the present invention method (and related program code 107):

When an intra-frequency measurement configuring event 1a is set up, the UE shall:

1>create a variable TRIGGERED_{—}1A_EVENT related to that measurement, which shall initially be empty;

1>delete this variable when the measurement is released.

When event 1A is configured in the UE, the UE shall:

1>if “Measurement quantity” is “pathloss” and Equation 1 below is fulfilled for one or more primary CPICHs, or if “Measurement quantity” is “CPICH Ec/N0” or “CPICH RSCP”, and Equation 2 below is fulfilled for one or more primary CPICHs, for each of these primary CPICHs:

2>if all required reporting quantities are available for that cell; and

2>if the equations have been fulfilled for a time period indicated by “Time to trigger”, and if that primary CPICH is part of cells allowed to trigger the event according to “Triggering condition 2”, and if that primary CPICH is not included in the “cells triggered” in the variable TRIGGERED_{—}1A_EVENT:

3>include that primary CPICH in the “cells recently triggered” in the variable TRIGGERED_{—}1A_EVENT.

1>if the value of “Reporting deactivations threshold” for this event is greater than or equal to the current number of cells in the active set or equal to 0, and if the number of cells included in the active set is less than “maxRL”, and any primary CPICHs are stored in the “cells recently triggered” in the variable TRIGGERED_{—}1A_EVENT:

2>if “Reporting interval” for this event is not equal to 0:

3>if the IE “Periodical reporting running” in the variable TRIGGERED_{—}1A_EVENT is set to FALSE:

4>start a timer with the value of “Reporting interval” for this event and set the IE “Periodical reporting running” in the variable TRIGGERED_{—}1A_EVENT to TRUE;

3>set “sent reports” for the primary CPICHs in “cells recently triggered” in the variable TRIGGERED_{—}1A_EVENT to 1.

2>send a measurement report with IEs set as below:

3>set in “intra-frequency measurement event results”: “Intrafrequency event identity” to “1a”; and

3>include in “cell measurement event results” all entries of the “cells recently triggered” in the variable TRIGGERED_{—}1A_EVENT that are not part of the active set in descending order according to the configured measurement quantity taking into account the cell individual offset for each of those cells;

3>set the IE “measured results” and the IE “additional measured results” according to subclause 8.4.2, not taking into account the cell individual offset for each cell.

2>move all entries from “cells recently triggered” to “cells triggered” in the variable TRIGGERED_{—}1A_EVENT.

1>if the timer for the periodical reporting has expired:

2>if any primary CPICH is included in the “cells triggered” in the variable TRIGGERED_{—}1A_EVENT, and not included in the current active set:

3>if “Reporting interval” for this event is not equal to 0, and if “Amount of reporting” is greater than “sent reports” stored for any of these primary CPICHs, in “cells triggered” in the variable TRIGGERED_{—}1A_EVENT:

4>increment the stored counter “sent reports” for all CPICHs in “cell triggered” in variable TRIGGERED_{—}1A_EVENT;

4>start a timer with the value of “Reporting interval” for this event;

4>send a measurement report with IEs set as below:

5>set in “intra-frequency measurement event results”: “Intrafrequency event identity” to “1a”; and

5>include in “cell measurement event results” all entries of the variable TRIGGERED_{—}1A_EVENT with value of IE “sent reports” smaller than value of “Amount of reporting” that are not part of the active set in descending order according to the configured measurement quantity taking into account the cell individual offset for each of those cells;

5>set the IE “measured results” and the IE “additional measured results” according to subclause 8.4.2, not taking into account the cell individual offset for each cell.

4>if “sent reports” in variable TRIGGERED_{—}1A_EVENT is greater than “Amount of reporting” for all entries:

5>set the IE “Periodical Reporting running” in the variable TRIGGERED_{—}1A_EVENT to FALSE and disable the timer for the periodical reporting.

1>if “Measurement quantity” is “pathloss” and Equation 3 below is fulfilled for a primary CPICH, or if “Measurement quantity” is “CPICH Ec/NO” or “CPICH RSCP”, and Equation 4 below is fulfilled for a primary CPICH:

2>if that primary CPICH is included in the “cells triggered” in the variable TRIGGERED_{—}1A_EVENT:

3>remove the entry of that primary CPICH from “cells triggered” in the variable TRIGGERED_{—}1A_EVENT.

3>if no entry in the variable TRIGGERED_{—}1A_EVENT has a value of “sent reports” smaller than “Amount of reporting”:

4>stop the reporting interval timer;

4>set the IE “Periodical reporting running” in the variable TRIGGERED_{—}1A_EVENT to FALSE.

This event is only applicable to the CELL_DCH state. Upon transition to CELL_DCH the UE shall:

1 >Include the primary CPICH of all cells in the current active set into the “cells triggered” in the variable TRIGGERED_{—}1A_EVENT.

Equation 1 (Triggering condition for pathloss)

$$10 \cdot Log {M}_{New} + {CIO}_{New} \leq W \cdot 10 \cdot Log ( 1 / {\sum }_{i = 1}^{{N}_{A}} ( 1 / {M}_{i} ) ) + ( 1 - W ) \cdot 10 \cdot Log {M}_{Best} + ( {R}_{1 a} - {H}_{1 a} / 2 ) ,$$

Equation 2 (Triggering condition for all the other measurement quantities)

$$10 \cdot Log {M}_{New} + {CIO}_{New} \geq W \cdot 10 \cdot Log ( {\sum }_{i = 1}^{{N}_{A}} {M}_{i} ) + ( 1 - W ) \cdot 10 \cdot Log {M}_{Best} - ( {R}_{1 a} - {H}_{1 a} / 2 ) .$$

Equation 3 (Leaving triggering condition for pathloss)

$$10 \cdot Log {M}_{New} + {CIO}_{New} > W \cdot 10 \cdot Log ( 1 / {\sum }_{i = 1}^{{N}_{A}} ( 1 / {M}_{i} ) ) + ( 1 - W ) \cdot 10 \cdot Log {M}_{Best} + ( {R}_{1 a} + {H}_{1 a} / 2 ) ,$$

Equation 4 (Leaving triggering condition for all the other measurement quantities)

$$10 \cdot Log {M}_{New} + {CIO}_{New} < W \cdot 10 \cdot Log ( {\sum }_{i = 1}^{{N}_{A}} {M}_{i} ) + ( 1 - W ) \cdot 10 \cdot Log {M}_{Best} - ( {R}_{1 a} + {H}_{1 a} / 2 ) ,$$

The variables in the formula are defined as follows: M_{New} is the measurement result of the cell entering the reporting range.

CIO_{New} is the individual cell offset for the cell entering the reporting range if an individual cell offset is stored for that cell. Otherwise it is equal to 0.

Mᵢ is a measurement result of a cell not forbidden to affect reporting range in the active set.

N_{A} is the number of cells not forbidden to affect reporting range in the current active set.

For pathloss

M_{Best} is the measurement result of the cell not forbidden to affect reporting range in the active set with the lowest measurement result, not taking into account any cell individual offset.

for other measurements quantities.

M_{Best} is the measurement result of the cell not forbidden to affect reporting range in the active set with the highest measurement result, not taking into account any cell individual offset.

W is a parameter sent from UTRAN to UE.

R₁ₐ is the reporting range constant.

H₁ₐ is the hysteresis parameter for the event 1a.

If the measurement results are pathloss or CPICH-Ec/No then M_{New}, Mᵢ and M_{Best} are expressed as ratios.

If the measurement result is CPICH-RSCP then M_{New}, Mᵢ and M_{Best} are expressed in mW.

The following steps indicate how virtual active set is handled by the present invention method(and related program code 107) during inter-frequency measurement:

If the IE “Intra-frequency measurement reporting criteria” is stored for an inter-frequency measurement, the UE shall: 1>if Event 1a is configured in that IE, when this event is triggered (according to the criteria described in subclause 14.2.1.1) by a cell allowed to affect the reporting range (i.e. not included in the IE “Cells forbidden to affect reporting range” if that IE is included) for a non-used frequency considered in that measurement:

2>if the “Reporting deactivation threshold” is equal to 0 and the number of cells included in the virtual active set is smaller than “maxRL”; or

2>if the “Reporting deactivation threshold” is different from 0 and the number of cells included in the virtual active set for that frequency is less than or equal to the “Reporting deactivation threshold”:

3>if the IE “UE autonomous update mode” is set to “on” or “on with no reporting”:

4>add the primary CPICH that enters the reporting range to the “virtual active set”.

3>if the IE “UE autonomous update mode” is set to “on” or “off”:

4>send a measurement report with IEs set as below:

5>set the Measurement identity to the identity of the inter-frequency measurement;

5>set the CHOICE event result in the IE Event results to Intra-frequency measurement event results, Intra-frequency event identity to 1a, and in “Cell measurement event results” the CPICH info of the cell that triggered the event;

5>do not include the IE “measured results”.

1>if Event 1b was configured, when this event is triggered (according to the criteria described in subclause 14.2.1.2) by a cell allowed to affect the reporting range (i.e. not included in the IE “Cells forbidden to affect reporting range” if that IE is included) for a non-used frequency considered in that measurement:

2>if the IE “UE autonomous update mode” is set to “on” or “on with no reporting” and if the number of cells included in the virtual active set is greater than 1:

3>remove the primary CPICH that leaves the reporting range from the “virtual active set”.

2>if the IE “UE autonomous update mode” is set to “on” or “off”:

3>send a measurement report with IEs set as below:

4>set the Measurement identity to the identity of the inter-frequency measurement;

4>set the CHOICE event result in the IE Event results to Intra-frequency measurement event results, Intra frequency event identity to 1b, and in “Cell measurement event results” the CPICH info of the cell that triggered the event;

4>do not include the IE “measured results”.

1>if Event 1c was configured, when this event is triggered by a cell for a frequency considered in that measurement (according to the criteria described in subclause 14.1.2.3):

2>if the “Reporting activation threshold” is equal to 0, or if the “Reporting activation threshold” is different from 0 and the number of cells included in the virtual active set for that frequency is greater than or equal to the “Reporting activation threshold”:

3>if the IE “UE autonomous update mode” is set to “on” or “on with no reporting”:

4>replace an active primary CPICH in the “virtual active set” with a non-active primary CPICH that has become better than the active primary CPICH.

3>if the IE “UE autonomous update mode” is set to “on” or “off”:

4>send a measurement report with IEs set as below:

5>set the Measurement identity to the identity of the inter-frequency measurement;

5>set the CHOICE event result in the IE Event results to Intra-frequency measurement event results, Intra-frequency event identity to 1c, and in “Cell measurement event results” the first entry as the CPICH info of the cell that triggered the event, and the rest of the entries as the cells that were in the virtual active set before the event occurred and that are worse than the cell that triggered the event, in the order of their measured value (best one first);

5>do not include the IE “measured results”.

If the IE “Intra-frequency measurement reporting criteria” is not stored for that inter-frequency measurement, the UE shall:

1>apply the events of type 1a, 1b and 1c that were defined for the used frequency in other stored measurements of type “intra-frequency” at the time the inter-frequency measurement was set up; and

1>update the virtual active set for the non-used frequencies considered in that measurement according to the following rules:

2>if several events of type 1a (resp. 1b, 1c) were defined for the used frequency when the inter-frequency measurement was set up, only the first 1a event (resp 1b, 1c) that was defined in the measurement with the lowest measurement identity shall apply to the non-used frequencies;

2>all the cells considered in the inter-frequency measurements shall be able to affect the reporting range for event 1a and 1b. (i.e. the IE “Cells forbidden to affect reporting range” possibly stored for the intra-frequency measurements on the used frequency does not apply to the non-used frequencies considered in the inter-frequency measurement);

2>the IEs “amount of reporting” and “reporting interval” that were stored for the intra-frequency measurements on the used frequency shall not be considered if reports of the virtual active set updates are needed.

1>if event 1a is applicable to the non-used frequencies considered in the inter-frequency measurement, when this event is triggered (according to the criteria described in subclause 14.1.2.1) by a cell for a non-used frequency considered in that measurement:

2>if the “Reporting deactivation threshold” is equal to 0 and the number of cells included in the virtual active set is smaller than “maxRL”; or

2>if the “Reporting deactivation threshold” is different from 0 and the number of cells included in the virtual active set for that frequency is less than or equal to the “Reporting deactivation threshold”:

3>if the IE “UE autonomous update mode” is set to “on” or “on with no reporting”:

4>add the primary CPICH that enters the reporting range to the “virtual active set”.

3>if the IE “UE autonomous update mode” is set to “on” or “off”:

4>send a measurement report with IEs set as below:

5>set the Measurement identity to the identity of the inter frequency measurement;

5>set the CHOICE event result in the IE Event results to Intra-frequency measurement event results, Intra-frequency event identity to 1a, and in “Cell measurement event results” the CPICH info of the cell that triggered the event;

5>do not include the IE “measured results”.

1>if event 1b is applicable for the non-used frequencies considered in that inter-frequency measurement, when this event is triggered (according to the criteria described in subclause 14.1.2.2) by a cell for a non-used frequency considered in that measurement:

2>if the IE “UE autonomous update mode” is set to “on” or “on with no reporting” and if the number of cells included in the virtual active set is greater than 1:

3>remove the primary CPICH that leaves the reporting range from the “virtual active set”.

2>if the IE “UE autonomous update mode” is set to “on” or “off”, send a measurement report with IEs set as below:

3>set the Measurement identity to the identity of the inter-frequency measurement;

3>set the CHOICE event result in the IE Event results to Intra-frequency measurement event results, Intra-frequency event identity to 1b, and in “Cell measurement event results” the CPICH info of the cell that triggered the event;

3>do not include the IE “measured results”.

1>if event 1c is applicable for the non-used frequencies considered in that inter-frequency measurement, when this event is triggered (according to the criteria described in subclause 14.1.2.3) by a cell for a non-used frequency considered in that measurement:

2>if the “Reporting activation threshold” is equal to 0, or if the “Reporting activation threshold” is different from 0 and the number of cells included in the virtual active set for that frequency is greater than or equal to the “Reporting activation threshold”:

3>if the IE “UE autonomous update mode” is set to “on” or “on with no reporting”:

4>replace an active primary CPICH in the “virtual active set” with a non-active primary CPICH that has become better than the active primary CPICH.

3>if the IE “UE autonomous update mode” is set to “on” or “off”:

4>send a measurement report with IEs set as below:

5>set the Measurement identity to the identity of the inter-frequency measurement.

5>set the CHOICE event result in the IE Event results to Intra-frequency measurement event results, Intra-frequency event identity to 1c, and in “Cell measurement event results” the first entry as the CPICH info of the cell that triggered the event, and the rest of the entries as the cells that were in the virtual active set before the event occurred and that are worse than the cell that triggered the event, in the order of their measured value (best one first);

5>do not include the IE “measured results”.

It should be noted that the above steps are very similar to the prior art, and should be familiar to one reasonably skilled in this particular field of wireless communications protocols. The present invention, however, adds an additional check to ensure that the number of cells included in the active set is less than “maxRL” for a report to be sent to the UTRAN.

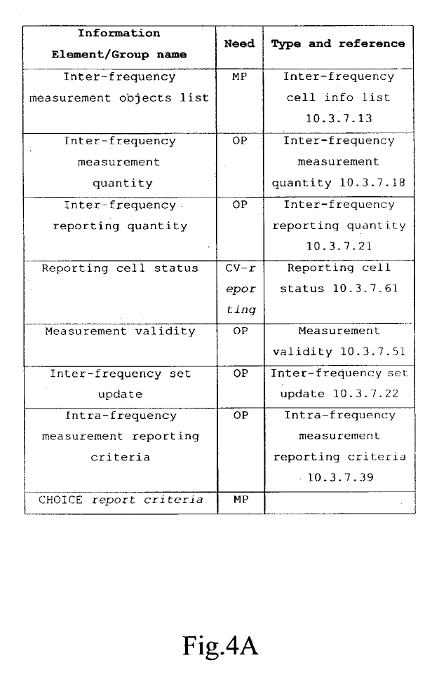

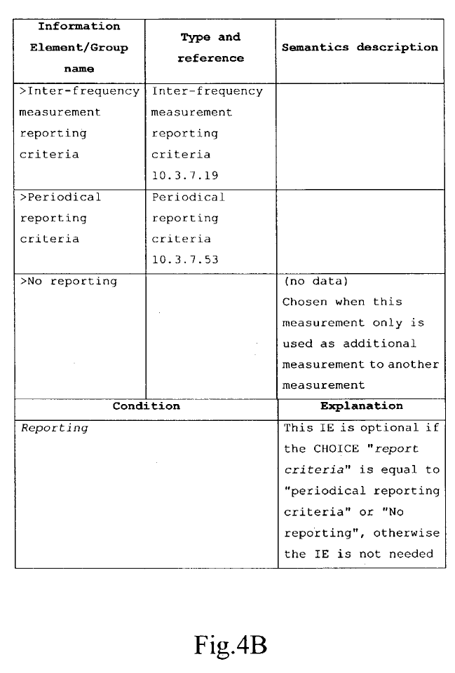

Please refer to FIGS. 4A and 4B. As another aspect of the present invention, it is desired to change the data structure of the MEASUREMENT CONTROL message so as to remove the limitations placed upon the UMTS by the prior art data structure. Specifically, the “Inter-frequency measurement” IE, as per TS 25.331, section 10.3.7.16, is modified so as to be able to simultaneously support both the “Intra-frequency measurement reporting criteria” IE and the “Inter-frequency measurement reporting criteria” IE. FIGS. 4A and 4B provide a first embodiment of the “Inter-frequency measurement” IE.

In FIGS. 4A and 4B, the “Intra-frequency measurement reporting criteria” IE is made an optional (OP) IE, whereas the “Inter frequency measurement reporting criteria” IE is made a CHOICE IE. Hence, with the above data structure, it is possible to simultaneously support both the “Intra-frequency measurement reporting criteria” IE and the “Inter-frequency measurement reporting criteria” IE. Alternatively, as a second embodiment, it is possible to make the “Inter-frequency measurement reporting criteria” IE the OP IE, and the “Intra-frequency measurement reporting criteria” IE the CHOICE IE. Finally, as a third embodiment, it is possible to make both the “Intra-frequency measurement reporting criteria” IE and the “Inter-frequency measurement reporting criteria” IE OP IEs.

Using either one of the above three data structures, it is possible for the UTRAN to send a MEASUREMENT CONTROL message to the UE 100 that contains both the “Intra-frequency measurement reporting criteria” IE and the “Inter-frequency measurement reporting criteria” IE. The program code 107 of the UE 100 is modified to support either one of the three embodiments of the “Inter-frequency measurement” IE contained in the MEASUREMENT CONTROL message, and to act upon the IEs contained therein. By way of example, the UTRAN can configure the UE 100 to perform both autonomous updating of the virtual active set 110 (i.e. the “Intra-frequency measurement reporting criteria”IE is included in the MEASUREMENT CONTROL message), and with the same MEASUREMENT CONTROL message can also configure the UE 100 to perform inter-frequency measurement reporting (i.e., the “Inter-frequency measurement reporting criteria” IE is also included in the MEASUREMENT CONTROL message). In response to receiving such a MEASUREMENT CONTROL message, the UE 100 both updates the virtual active set 110, and also sends any required inter-frequency measurement reports to the UTRAN. As a result, the UTRAN can configure the UE 100 to perform both autonomous updating of the virtual active 110 set and inter-frequency measurement reporting with the same MEASUREMENT CONTROL message.

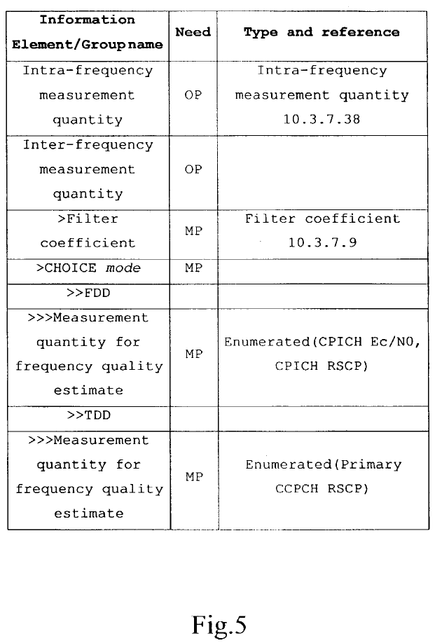

Please refer to FIG. 5. Additionally, the “Inter-frequency measurement quantity” IE, as per TS 25.331, section 10.3.7.18, is modified so as to be able to simultaneously support both the “Intra-frequency measurement quantity” IE and the “Inter-frequency measurement quantity” IE, that are used for assigning the measurement quantity of corresponding Intra-frequency/Inter-frequency measurement reporting criteria. FIG. 5 provides a first embodiment of the “Inter-frequency measurement quantity” IE.

In FIG. 5, the “Intra-frequency measurement quantity” IE and the “Inter-frequency measurement quantity” IE are made optional (OP) IEs. Hence, with the above data structure, it is possible to simultaneously support both the “Intra-frequency measurement quantity” IE and the “Inter frequency measurement quantity” IE.

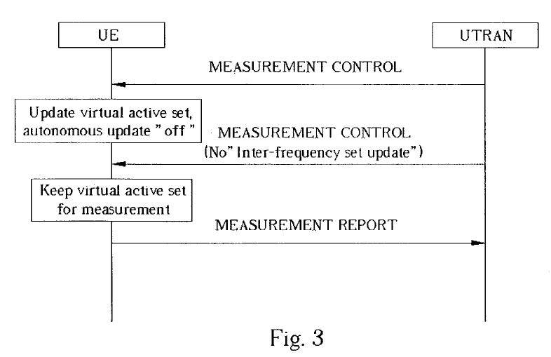

To ensure that the MEASUREMENT CONTROL messages from the UTRAN to the UE are not forced to be unduly large, the present invention modifies the manner in which the UE 100 processes a received MEASUREMENT CONTROL message from the UTRAN. In particular, if the “Inter-frequency set update” IE is not included in the MEASUREMENT CONTROL message, and if the “UE autonomous update mode” IE already stored within the UE 100 for the inter-frequency measurement is set to “Off”, the UE 100 does not remove the possibly existing virtual active set 110 of the non-used frequency considered in that measurement, and so does not consider the virtual active set 110 for that non-used frequency as empty. FIG. 3 is a simple message sequence chart that illustrates example processing of MEASUREMENT CONTROL messages according to the present invention method. Initially, a MEASUREMENT CONTROL message is sent from the UTRAN to the UE 100, which contains the “UE autonomous update mode” IE set to “Off”, and holds a list of cells that are to be used for the virtual active set 110. In response to receiving this message, the UE 100 configures the virtual active set 110 with cells 110a as indicated by the received MEASUREMENT CONTROL message, and sets its “UE autonomous update mode” IE 120 to “Off”, as per the received message. At a later time, the UTRAN wishes to modify some IEs of this measurement that are not related to the initializing or updating of the virtual active set 110. The UTRAN thus builds a MEASUREMENT CONTROL message containing IEs related to the desired action, but this message does not include the “Inter frequency set update” IE. The UTRAN then sends this second MEASUREMENT CONTROL message to the UE 100. The program code 107 of the UE 100 processes the IEs contained within this second message in a standard manner. However, noting that the second MEASUREMENT CONTROL message contains no “Inter-frequency set update” IE, and that the “UE autonomous update mode”IE 120 is already set to “Off”, the program code 107 keeps the same virtual active set 110 for this measurement, and does not consider the virtual active set 110 empty. Consequently, the UTRAN is not forced to continually supply the virtual active set for the UE 100 every time a MEASUREMENT CONTROL message is sent that is related to that non-used frequency measurement, or always include the IE “Inter-frequency set update” (which is an optional IE) in the message and set the “UE autonomous update mode” IE to “Off” when UTRAN wishes to modify some IEs of this measurement that are not related to the initializing or updating of the virtual active set 110. This reduces the required size of the MEASUREMENT CONTROL message, and hence conserves radio resources.

Finally, to ensure that the UE 100 properly initializes the virtual active set 110 under all conditions, and properly reports the cells 110a of the virtual active set 110 to the UTRAN, the following changes are made to the program code 107 with respect to the prior art UE. If the “UE autonomous update mode” IE received in a MEASUREMENT CONTROL message is set to “on” or “on with no reporting”, or if the received “Replacement activation threshold”IE or “Reporting deactivation threshold” IE included in the “Intra-Frequency measurement”IE has changed with respect to those already stored in the UE 100 (i.e. any one of these IEs received is not the same as it was previously stored in the variable MEASUREMENT_IDENTITY within the UE 100, meaning that N₁ₐ or N_{1c} has changed), or if the number of cells on non used frequency Fᵢ considered in that inter-frequency measurement is changed (i.e. if the “Inter-frequency cell info list”IE is received, meaning that N_{Cells Fi} has changed), the UE 100 initializes the virtual active set 110 with the best Nᵢ 113 cells 110a for each non-used frequency. And if the “UE autonomous update mode”IE received in the MEASUREMENT CONTROL message is set to “on”, or if the received “Replacement activation threshold”IE or “Reporting deactivation threshold” IE included in the “Intra-Frequency measurement”IE is changed, or if the number of cells on non-used frequency F considered in that inter-frequency measurement is changed, the UE 100 reports all the cells 110a included in the initial virtual active set 110 to the UTRAN. Also, Nᵢ 113 is ensured to not exceed maxRL 112. How the UE 100 performs (i.e., steps performed by the program code 107) when a MEASUREMENT CONTROL message is received that sets up or modifies an inter-frequency measurement, and that includes the “Inter-frequency set update” IE and/or the “Intra-Frequency reporting quantity” IE is described below.

1>if the IE “Intra-Frequency measurement reporting criteria” is included in the MEASUREMENT CONTROL message, or if it was previously stored and if the IE “Inter-frequency set update” was included in the MEASUREMENT CONTROL message:

2>if the IE “UE autonomous update mode” received is set to “on” or “on with no reporting”; or

2>if the IE “Replacement activation threshold” or IE “Reporting deactivation threshold” stored in the variable MEASUREMENT_IDENTITY for that inter-frequency measurement is changed due to the received message; or

2>if the number of cells on non-used frequency Fᵢ considered in that inter-frequency measurement is changed due to the received message, i.e. if the number of neighbouring cells included in the IE “inter-freq cell info list” of variable CELL INFO LIST is changed due to the received message:

3>for each non-used frequency Fᵢ considered in the measurement:

4>include in the initial virtual active set the Nᵢ cells that have either the greatest downlink E_{C}/N₀, the greatest downlink RSCP after despreading, or the lowest pathloss (depending on what is indicated in the IE “inter-frequency measurement quantity”), among the cells on frequency Fᵢ considered in that inter-frequency measurement, where:

5>if event 1a is configured in the “Intra-Frequency measurement reporting criteria”:

N=min(N₁ₐ, N_{Cells Fi}) if N₁ₐ≠0 and Nᵢ=min(N_{Cells Fi}, maxRL) otherwise.

where:

N₁ₐ is the “Reporting deactivation threshold”

included in the “Intra-Frequency measurement” IE received for that inter-frequency measurement for event 1a.

N_{Cell Fi} is the number of cells on frequency Fᵢ considered in that inter-frequency measurement.

5>else, if event 1c is configured in the “Intra-Frequency measurement reporting criteria”:

Nᵢ=min(N_{1c}, N_{Cells Fi}) if N_{1c}≠0 and Nᵢ=min(N_{Cells Fi}, maxRL) otherwise.

where:

N_{1c} is the “Replacement activation threshold” included in the “Intra-Frequency measurement” IE received for that inter-frequency measurement for event 1c.

N_{Cells Fi} is the number of cells on frequency Fᵢ considered in that inter-frequency measurement.

5>else:

Nᵢ=min(N_{Cells Fi}, maxRL)

where:

N_{Cells Fi} is the number of cells on frequency Fᵢ considered in that inter-frequency measurement.

2>if the IE “UE autonomous update mode” received is set to “on”; or

2>if the IE “Replacement activation threshold” or IE “Reporting deactivation threshold” stored in the variable MEASUREMENT_IDENTITY for that inter-frequency measurement is changed due to the received message; or

2>if the number of cells on non-used frequency Fᵢ considered in that inter-frequency measurement is changed due to the received message, i.e. if the number of neighbouring cells included in the IE “inter-freq cell info list” of variable CELL INFO LIST is changed due to the received message:

3>if event 1a is configured in the “Intra-Frequency measurement reporting criteria”:

4>send a MEASUREMENT REPORT with IEs set as follows:

5>set the Measurement identity to the identity of the inter-frequency measurement;

5>set the CHOICE event result in the IE Event results to Intra-frequency measurement event results, Intra-frequency event identity to 1a, and in “Cell measurement event results” the CPICH info of all the cells included in a virtual active set of the non-used frequency considered in the inter-frequency measurement;

5>do not include the IE “measured results”.

3>else, if event 1c is configured in the

“Intra-Frequency measurement reporting criteria”:

4>send a measurement report with IEs set as follows:

5>set the Measurement identity to the identity of the inter-frequency measurement;

5>set the CHOICE event result in the IE Event results to Intra-frequency measurement event results, Intra-frequency event identity to 1c, and in “Cell measurement event results” the primary CPICH info of all the cells included in the virtual active set of the frequency considered in the inter-frequency measurement;

5>do not include the IE “measured results”.

2>if the IE “Inter-frequency set update” is included in the message and if the IE “UE autonomous update mode” is set to “Off”:

3>if the IE “Measurement command” is set to “Modify”, if the value previously stored for the IE “UE autonomous update mode” was also “Off” and if the IE ”Intra-frequency measurement reporting criteria” was not included in the message:

4>apply the modifications indicated in the “Inter-frequency set update” to the virtual active set that was valid before the message was received for the non-used frequency considered in that inter-frequency measurement.

3>otherwise:

4>remove the possibly existing virtual active set of the non-used frequency considered in that measurement; and

4>set the initial virtual active set for it according to the “Inter-frequency set update” included in the message.

2>if the IE “Inter-frequency set update” is not included in the message and if the IE “UE autonomous update mode” stored for the inter-frequency measurement is set to “Off”:

3>remove the possibly existing virtual active set of the non-used frequency considered in that measurement; and

3>consider the virtual active set for it as empty.

1>if the IE “Intra-Frequency measurement reporting criteria” was not included in the MEASUREMENT CONTROL message:

2>if the IE “UE autonomous update mode” is set to “on” or “on with no reporting”:

3>for each non-used frequency Fᵢ considered in the measurement:

4>include in the initial virtual active set the Nᵢ cells that have either the greatest downlink E_{C}/N₀ or the greatest downlink RSCP after despreading or the lowest pathloss (depending on what is indicated in the IE “inter-frequency measurement quantity”), among the cells on frequency Fᵢ considered in that inter-frequency measurement, where:

5>if event 1a is configured for the used frequency in an intra-frequency measurement:

Nᵢ=min(N₁ₐ, N_{Cells Fi}) if N₁ₐ≠0 and Nᵢ=min(N_{Cells Fi}, maxRL) otherwise.

where:

N₁ₐ is the “Reporting deactivation threshold”

included in the intra-frequency measurement for the first event 1a defined in the intra-frequency measurement with the lowest identity.

N_{Cells Fi} is the number of cells on frequency Fᵢ considered in that inter-frequency measurement.

5>else, if event 1c is configured for the used frequency in an intra-frequency measurement:

Nᵢ=min(N_{1c}, N_{Cells Fi}) if N_{1c}≠0 and Nᵢ=min(N_{Cells Fi}, maxRL) otherwise.

where:

N_{1c} is the “Replacement activation threshold”

included in the “Intra Frequency measurement” for the first event 1c defined in the intra-frequency measurement with the lowest identity.

N_{Cells Fi} is the number of cells on frequency Fᵢ considered in that inter-frequency measurement.

5>else:

Nᵢ=min(N_{Cells Fi}, maxRL)

where:

N_{Cells Fi} is the number of cells on frequency Fᵢ considered in that inter-frequency measurement,

3>if the IE “UE autonomous update mode” is set to “on”:

4>if event 1a is configured for the used frequency in an intra-frequency measurement:

5>send a measurement report with IEs set as follows:

6>set the Measurement identity to the identity of the inter-frequency measurement;

6>set the CHOICE event result in the IE Event results to Intra-frequency measurement event results, Intra-frequency event identity to 1a, and in “Cell measurement event results” the CPICH info of all the cells included in the initial virtual active set of the non-used frequency considered in that measurement;

6>do not include the IE “measured results”.

4>else, if event 1c is configured for the used frequency in an intra-frequency measurement:

5>send a measurement report with IEs set as follows:

6>set the Measurement identity to the identity of the inter-frequency measurement;

6>set the CHOICE event result in the IE Event results to Intra-frequency measurement event results, Intra-frequency event identity to 1c, and in “Cell measurement event results” the CPICH info of all the cells included in the initial virtual active set of the non-used frequency considered in that measurement;

6>do not include the IE “measured results”.

2>if the IE “UE autonomous update mode” is set to “off”:

3>set the initial virtual active set of the non-used frequency considered in that inter-frequency measurement according to what is included in the IE “Inter-frequency set update” included in the message; and

3>if the IE “Inter-frequency set update” was not received:

4>set the initial virtual active set for the frequencies considered in that measurement to be empty.

In contrast to the prior art, the present invention prevents the number of cells Nᵢ in the virtual active set on the UE from exceeding “maxRL”, ensuring that measurements for the virtual active set are conformal to conditions imposed upon the active set. Hence, 1a type events that would normally lead to the addition of a cell to the virtual active set are ignored if the virtual active set is full, and are not reported back to the UTRAN to avoid the unnecessary loading of bandwidth with useless messages. To improve flexibility, both “Intra-frequency reporting criteria” and “Inter-frequency reporting criteria” IEs can be present simultaneously in a MEASUREMENT CONTROL message. When processing a MEASUREMENT CONTROL message according to the present invention, if no “Inter-frequency set update” IE is included and “UE autonomous update mode” stored in the UE is “Off”, the UE does not remove the virtual active set, but continues to use it for Inter-frequency measurements. If the “Replacement activation threshold”IE or “Reporting deactivation threshold” IE included in a “Intra-Frequency measurement”IE has changed with respect to those already stored in the present invention UE, or if the inter-freq cell info list is changed, the present invention UE initializes the virtual active set 110 with the best Nᵢ cells 110a for each non-used frequency. Finally, if the received “Replacement activation threshold”IE or “Reporting deactivation threshold” IE included in the “Intra-Frequency measurement”IE is changed, or if the inter-freq cell info list is changed, the present invention UE reports all the cells included in the initial virtual active set 110 to the UTRAN.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for maintaining a virtual active set in a wireless device, the wireless device comprising an active set, the active set comprising up to maxRL cells, the method comprising:
in response to a first MEASUREMENT CONTROL message, generating a virtual active set containing Nᵢ cells, wherein Nᵢ is less than or equal to maxRL;
receiving a type 1a event associated with a first cell;
in response to the type 1a event, determining the number of cells in the virtual active set at the time of the type 1a event; and
inserting the first cell into the virtual active set only if the number of cells in the virtual active set at the time of the type 1a event is less than maxRL to ensure that the number of cells in the virtual active set does not exceed maxRL.

2. The method of claim 1 further comprising:
sending a MEASUREMENT REPORT message to a second wireless device only if the number of cells in the virtual active set at the time of the type 1a event is less than maxRL.

3. The method of claim 1 further comprising:
sending a MEASUREMENT REPORT message to a second wireless device only if the virtual active set is changed in response to the type 1a event.

4. The method of claim 1 further comprising:
replacing a second cell in the virtual active set with the first cell if the number of cells in the virtual active set at the time of the type 1a event is equal to maxRL.

5. The method of claim 1 wherein generating the virtual active set containing Nᵢ cells comprises calculating Nᵢ as a function of a plurality of parameters, and Nᵢ is forced to be less than or equal to maxRL.

6. The method of claim 5 further comprising:
recalculating Nᵢ if any of the parameters are changed in response to receiving a second MEASUREMENT CONTROL message after receiving the first MEASUREMENT CONTROL message; and initializing the virtual active set according to the recalculated value of Nᵢ.

7. The method of claim 6 wherein Nᵢ is recalculated if any of N₁ₐ, N_{1c} or N_{CellsFi} are changed in response to receiving the second MEASUREMENT CONTROL message.

8. The method of claim 1 further comprising:
sending a MEASUREMENT REPORT message to a second wireless device if a “UE autonomous update mode”information element (IE)received in the first MEASUREMENT CONTROL message is set to “on”, the received “Replacement activation threshold”IE included in an “Intra-Frequency measurement”IE is changed, a “Reporting deactivation threshold” IE included in the “Intra-Frequency measurement”IE is changed, or the number of cells on non-used frequency Fᵢ considered in an inter-frequency measurement is changed;
wherein the MEASUREMENT REPORT message includes all cells in the virtual active set.

9. The method of claim 1 wherein the first MEASUREMENT CONTROL message contains a “UE autonomous update mode” information element (IE) set to “Off”, and a list of cells that are used to generate the virtual active set, the method further comprising:
receiving a second MEASUREMENT CONTROL message that does not contain an “Inter-frequency set update” IE;
in response to receiving the second MEASUREMENT CONTROL message and the “UE autonomous update mode” IE within the wireless device simultaneously being set to “Off”, the wireless device keeping the virtual active set as the virtual active set existed when the second MEASUREMENT CONTROL message was received so that the virtual active set is not considered empty.

10. The method of claim 1 wherein the first MEASUREMENT CONTROL message contains both an “Intra-frequency measurement reporting criteria” information element (IE) and an “Inter-frequency measurement reporting criteria” IE, the method further comprising:
the wireless device processing the received “Intra-frequency measurement reporting criteria” IE; and the wireless device processing the received “Inter-frequency measurement reporting criteria” IE.

11. The method of claim 10 wherein the “Intra-frequency measurement reporting criteria” IE is an optional (OP) IE, and the “Inter-frequency measurement reporting criteria” IE is a CHOICE IE.

12. The method of claim 10 wherein the “Intra-frequency measurement reporting criteria” IE is a CHOICE IE, and the “Inter-frequency measurement reporting criteria” IE is an optional (OP) IE.

13. The method of claim 10 wherein both of the “Intra-frequency measurement reporting criteria” IE and the “Inter-frequency measurement reporting criteria” IE are optional (OP) IEs.

14. An improved wireless device comprising a central processing unit (CPU) and memory electrically connected to the CPU, the memory containing program coded executable by the CPU for performing the following steps:
in response to the wireless device receiving a first MEASUREMENT CONTROL message, generating a virtual active set containing Nᵢ cells, wherein Nᵢ is less than or equal to maxRL;
receiving a type 1a event associated with a first cell;
in response to the type 1a event, determining the number of cells in the virtual active set at the time of the type 1a event; and
inserting the first cell into the virtual active set only if the number of cells in the virtual active set at the time of the type 1a event is less than maxRL to ensure that the number of cells in the virtual active set does not exceed maxRL.

15. The wireless device of claim 14 wherein the program code further causes the CPU to perform the following step:
sending a MEASUREMENT REPORT message to a second wireless device only if the number of cells in the virtual active set at the time of the type 1a event is less than maxRL.

16. The wireless device of claim 14 wherein the program code further causes the CPU to perform the following step: sending a MEASUREMENT REPORT message to a second wireless device only if the virtual active set is changed in response to the type 1a event.

17. The wireless device of claim 14 wherein the program code further causes the CPU to perform the following step:
replacing a second cell in the virtual active set with the first cell if the number of cells in the virtual active set at the time of the type 1a event is equal to maxRL.

18. The wireless device of claim 14 wherein generating the virtual active set containing Nᵢ cells comprises calculating Nᵢ as a function of a plurality of parameters, and the program code forces Nᵢ to be less than or equal to maxRL.

19. The wireless device of claim 18 wherein the program code further causes the CPU to perform the following steps:
recalculating Nᵢ if any of the parameters are changed in response to receiving a second MEASUREMENT CONTROL message after receiving the first MEASUREMENT CONTROL message; and
initializing the virtual active set according to the recalculated value of Nᵢ.

20. The wireless device of claim 19 wherein N is recalculated if any of N₁ₐ, N_{1c} or N_{CellsFi} are changed in response to receiving the first MEASUREMENT CONTROL message.

21. The wireless device of claim 14 wherein the program code further causes the CPU to perform the following step:
sending a MEASUREMENT REPORT message to a second wireless device if a “UE autonomous update mode”information element (IE)received in the first MEASUREMENT CONTROL message is set to “on”, the received “Replacement activation threshold”IE included in an “Intra-Frequency measurement”IE is changed, a “Reporting deactivation threshold” IE included in the “Intra-Frequency measurement”IE is changed, or the number of cells on non-used frequency Fᵢ considered in an inter-frequency measurement is changed;
wherein the MEASUREMENT REPORT message includes all cells in the virtual active set.

22. The wireless device of claim 14 wherein the first MEASUREMENT CONTROL message contains a “UE autonomous update mode” information element (IE) set to “Off”, and a list of cells that are used to generate the virtual active set, and the program code further causes the CPU to perform the following steps:
receiving a second MEASUREMENT CONTROL message that does not contain an “Inter-frequency set update” IE;
in response to receiving the second MEASUREMENT CONTROL message and the “UE autonomous update mode” IE within the wireless device simultaneously being set to “Off”, the wireless device keeping the virtual active set as the virtual active set existed when the second MEASUREMENT CONTROL message was received so that the virtual active set is not considered empty.
